(19) United States
(12) Patent Application Publication
(10) Pub. No.: US 2009/0132688 A1
(43) Pub. Date: May 21, 2009

(54) Method For the Dynamic Service Configuration of a Technical System

(76) Inventors: Gerald Kafer, Munchen (DE); Reiner Schmid, Munchen (DE)

Correspondence Address: HARNESS, DICKEY & PIERCE, P.L.C., P.O.BOX 8910, RESTON, VA, 20195, US

(21) Appl. No.: 11/922,210

(22) PCT Filed: Jul. 5, 2006
(86) PCT No.: PCT/EP2006/063923

§ 371 Date: Dec. 14, 2007

(30) Foreign Application Priority Data
Jul. 15, 2005 (DE) 10 2005 033 231.5

(51) Int. Cl. G06F 15/16

(52) U.S. Cl. 709/223

(57) ABSTRACT

A method is disclosed for the dynamic service configuration of a technical system. According to at least one embodiment of the method: a) a functional task description is inputted and/or generated in a functional description language for an interaction task between at least one new initial service and at least one end service already existing in the technical system; b) combinations of initial services and end services for solving the interaction task are determined on the basis of the functional task description; c) a search for compatible services is carried out for at least part of the initial services, during which the initial service searches for services compatible therewith and the compatible services, in turn, search for services which are compatible with themselves, thus generating paths from successive compatible services, a path being defined as a solution path for the interaction task when the initial service of the path and the compatible end service correspond to a combination of initial services and end services discovered in step b); and d) one of the solution paths is selected and the interaction task is carried out along the selected solution path.

### PRIORITY STATEMENT

This application is the national phase under 35 U.S.C. § 371 of PCT International Application No. PCT/EP2006/063923 which has an International filing date of Jul. 5, 2006, which designated the United States of America and which claims priority on German Patent Application DE 10 2005 033 231.5 filed Jul. 15, 2005, the entire contents of which are hereby incorporated herein by reference.

### FIELD

At least one embodiment of the invention generally relates to a method for the dynamic service configuration of a technical system, having a plurality of services, each with one or more interfaces. In at least one embodiment, two services in the technical system are compatible, when a direct interaction of the one service with the other service can be implemented by way of compatible service interfaces.

### BACKGROUND

Many technical solutions today, for example in the field of home and/or building automation, are not achieved by a single technical device but by a plurality of different technical devices, which carry out very precisely specified tasks. The devices hereby provide one or more what are known as services, which can execute specific technical tasks. Service here and in the text below therefore refers to a unit of a technical device, which is provided to implement a specific technical task.

To monitor and control technical systems with a plurality of services and to use the functions of the systems, it is often necessary for an external technical device to be connected to the existing technical system. With such a connection, it is necessary in particular for the availability of the individual resources of the devices in the technical system to be taken into account. Such resources are for example bandwidths for data transmission predetermined by the system or the computation or storage capacity for information in the system.

What are known as discovery techniques are known from the prior art, with which a new device to be integrated into a technical system finds the individual services of the technical system in an automated manner, for example by way of UPnP (Universal Plug and Play) or by way of Bluetooth. Information about the devices existing in the system is provided in this manner but this information cannot be used to determine how the individual devices can be used in a resource-efficient manner.

Functional description languages are also known from the prior art, which are used to describe the functionalities of individual services in a network of services and to determine suitable functional paths between the services according to the functionalities. With the known functional description languages however the services used are determined beforehand and services cannot be incorporated in a dynamic manner.

### SUMMARY

In at least one embodiment of the invention a method and/or corresponding devices are created, which can be used to integrate new services in a technical system in a dynamic manner.

In at least one embodiment of the inventive method, a functional description language is used, it being possible in some instances to use a description language already known from the prior art. The description language, which includes a plurality of functional elements, is used to describe the existing services and those to be integrated in the system as well as possible interactions between the services by way of one or more functional elements. The functional element hereby reproduces a functionality of the corresponding service or the interaction. It is also possible here for a number of functional elements to be assigned to one service, in so far as the service can take on a number of functions. Similarly it is possible for a number of functional elements to be assigned to one interaction, in so far as different functions can be brought about with the interaction.

The following steps are implemented with at least one embodiment of the inventive method:

### Step a):

For an interaction task to be implemented in the technical system between one or more new initial services to be integrated in the technical system and one or more final services of the technical system, a functional task description in the functional description language is input directly or generated by way of an interface, which communicates with a user for example. The functional task description allows corresponding functional elements to be predetermined for the initial and final services and their interactions. The terms initial service and final service are to be understood in a general sense and can stand for any technical service to be integrated or already existing in the technical system. The words “initial” and “final” are only intended to express that a start-to-end relationship between two technical services is sought in at least one embodiment of the inventive method.

### Step b):

The functional task description and the functional elements assigned to the services and interactions are used to determine combinations of initial and final services, which achieve the interaction task to be implemented in the technical system.

### Step c):

If combinations of initial and final services have been found in step b), a search for compatible services is implemented for at least some of the initial services of the combinations, during which search the initial service searches for services compatible with it and the compatible services in turn search for services compatible with themselves, with the result that paths for successive compatible services are generated, with a path being defined as a solution path of the interaction task, when the initial service of the path and the compatible final service found correspond to a combination of initial service and final service found in step b). This allows a plurality of possible solution paths to be generated for the task set.

### Step d):

If solution paths were found in step c), one of the solution paths is selected and the interaction task is implemented along the selected solution path.

With at least one embodiment of the inventive method, therefore, not only is one solution found to the problem by direct interaction between two services but solutions are also determined, which resolve the problem by interposing a number of services. A suitable solution path can then be used for the problem, based on predetermined criteria, in particular on the availability of the resources of the individual services.

In a variant of at least one embodiment of the inventive method before implementation of step c), it is checked in an intermediate step whether the combinations of initial and final services determined in step b) comprise mutually compatible services. If so, these combinations of mutually compatible services are defined beforehand in each instance as a solution path, which can be taken into account when suitable solution paths are subsequently selected. In some instances the selection according to step d) can be implemented immediately, without searching for further possible solution paths.

In a particularly preferred variant of at least one embodiment of the inventive method the new initial services to be integrated in the technical system use a search method to determine the services already existing in the technical system. Search methods known from the prior art such as UPnP or Bluetooth for example are used for this purpose.

The services existing in the technical system and the functional elements assigned to these services are preferably stored in a storage unit and the search according to step c) is implemented in the storage unit. This allows the search for solution paths to be accelerated, since it is no longer necessary to search the whole technical system for existing services.

In a further variant of at least one embodiment of the inventive method the search for solution paths in step c) is implemented, until a predetermined number of solution paths has been found or until at least one abort criterion is satisfied. This limits the complexity of the search to a predetermined degree. The abort criterion here is preferably a timeout, in other words a predetermined maximum time interval set for the search. The timeout can preferably be changed dynamically.

To implement the search defined in step c), in one variant of at least one embodiment of the inventive method messages are sent between the services, containing the initial service of the path and one or more functional elements of the final service predetermined according to the functional task description. The identity of the service receiving the message is hereby preferably added to a message, in so far as a functional element predetermined according to the functional task description is not assigned to this service. The message thus generated is then in turn forwarded to compatible services. However should a functional element predetermined according to the functional task description be assigned to the service receiving the message, this service reports its identity back to the initial service. This allows the possible solution paths to be made known to the initial service.

In a particularly preferred variant of at least one embodiment of the inventive method predetermined restrictions, in particular relating to the physical resources of the services, are taken into account during the search in step c) and/or during the selection in step d). The restrictions here can include global restrictions valid in the whole technical system, which in particular describe desired characteristics of the interaction task to be implemented in the technical system. However the restrictions can also include local restrictions, only valid in a group of services, which relate in particular to the availability of physical resources in the group of services. By taking such restrictions into account it is possible to find the solution paths dynamically taking into account the current status of the technical system. This allows the incorporation of a new device in an automated manner as a function of the available resources of the technical system.

At least one embodiment of the inventive method is preferably implemented in a technical system, which includes a network made up of a plurality of technical devices, with one or more services of the technical system being contained in each device. In particular the initial services to be integrated in the technical system are contained in an individual device to be integrated in the technical system, in particular in a mobile device, for example a mobile radio device, a laptop or a PDA for example. The network can for example include a home and/or building automation system, which allows users to log into the system from outside and to carry out processes in the system, such as controlling the heating system or controlling entertainment electronic system devices for example.

In addition to the method described above, at least one embodiment of the invention also relates to a technical system including a plurality of services, with the technical system being configured in such a manner that at least one embodiment of the inventive method can be implemented in the technical system.

At least one embodiment of the invention also relates to a technical device including one or more services for implementing at least one embodiment of the inventive method, with:
means for inputting and/or generating a functional task description for an interaction task to be implemented in the technical system between initial services of the technical device to be integrated in the technical system and one or more final services already existing in the technical system according to step a) of at least one embodiment of the inventive method;
means for determining combinations of initial and final services, which achieve the interaction task to be implemented in the technical system, according to step b) of at least one embodiment of the inventive method;
means for initializing the search for solution paths according to step c) of at least one embodiment of the inventive method;
means for selecting solution paths according to step d) of at least one embodiment of the inventive method.

The technical device can preferably also function as a component already integrated in the technical system with a group of services, with the device for this purpose having means for processing messages from other devices, which are received during the search for solution paths.

At least one embodiment of the invention also relates to a computer program product with a program code stored on a machine-readable medium for executing at least one embodiment of the inventive method, when the program is run on a computer.

### BRIEF DESCRIPTION OF THE DRAWINGS

Example embodiments of the invention are described in detail below with reference to the accompanying figures, in which:

FIG. 1 shows a schematic diagram of the sequence of an embodiment of the inventive method;

FIG. 2 shows an example of an application of an embodiment of the inventive method in a building automation system;

FIG. 3 shows the schematic structure of a technical device, which can be integrated into a technical system according to an embodiment of the inventive method.

### DETAILED DESCRIPTION OF THE EXAMPLE EMBODIMENTS

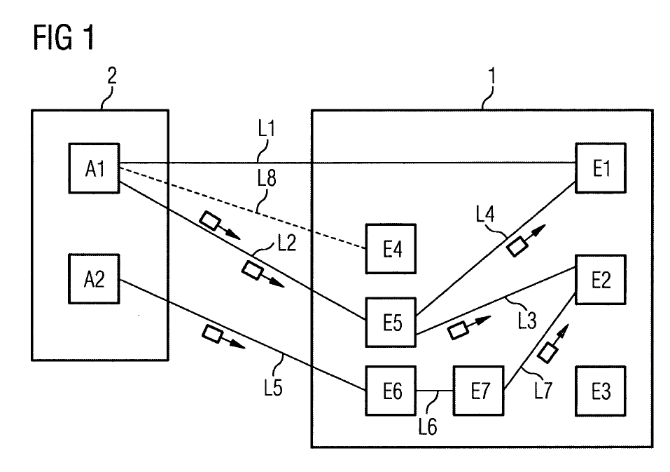

In the technical system 1 shown in FIG. 1 a new technical device 2 including the initial services A1 and A2 is to be integrated in the technical system 1. The technical system 1 here represents a network made up of a plurality of services E1, E2, E3, E4, E5, E6 and E7. The technical device 2 has what is known as a discovery mechanism, which can be used to provide information about the available services in the technical system 1. The discovery mechanism can be a UPnP mechanism or a Bluetooth-based mechanism for example. Such a discovery mechanism is sufficiently known, so there is no need to describe it in detail here. In the embodiment described here the device 2 first initializes this discovery mechanism, so that all the services existing in the system 1 are made known to the technical device 2.

The individual services of both the device 2 and the system 1 also have a device for checking the compatibility of the interfaces between the different services, for example in the form of an interface matcher component, which is also sufficiently known from the prior art. The functional scope of each individual service in the device 2 and in the system 1 as well as of the possible interactions of the respective service with other services is also described in a functional description language, with this description language including a plurality of functional elements, respectively reproducing the functionality of a service or an interaction.

In order to integrate the new device 2 in the technical system 1, a task is first predetermined, which is reproduced with the aid of the functional elements of the functional description language. The description language here comprises what are known as functional nodes, each of which stands for a functionality of a service, as well as interaction tokens, respectively standing for the functionality of an interaction. For example a video can be provided on the technical device 2 and the task can include displaying this video on a display.

The technical device 2 therefore includes the service <VIDEO>, which is to be connected to a service <DISPLAY> by way of an interaction token <link>. The task to be implemented in the technical system is then:

<VIDEO> <link> <DISPLAY>

Generally the unspecified interaction token <link> is specified in more detail for the unambiguous achievement of the task set and this can be done by the task setter themselves. Alternatively the technical device 2 can provide possible alternatives to more precise specification of the interaction token and in some instances also the functional nodes. In the example above, only the interaction token <show> results for the more detailed definition of the unspecified interaction token <link>, since the functional node <DISPLAY> can only be used to display videos. If the functional node <DISPLAY> were to be replaced by the functional node <TERMINAL>, there would be more options for the interaction token <link>, since a <TERMINAL> can also implement the recording of the video in the form of the interaction token <record>. The task setter could then formulate the following specific task in this instance:

<VIDEO> <link-show> <TERMINAL>

With this task it is specified that the display of a video on a terminal is desired.

A further example of a functional description of a task is a video playback on an external Bluetooth terminal. Such a task could appear as follows:

<VIDEO-my-video-MPEG> <link-show> <NETWORK-Bluetooth> <TERMINAL-large>

Descriptions of this type are generated automatically in the device 2, it being possible for a user of the device 2 to input the task on which the description is based for example by way of a graphic user interface. It is however also possible for descriptions of this type to be generated automatically when the device 2 is brought into contact with the technical system 1.

On the basis of the functional task description stored in the device 2 it is then determined in a first step which services in the technical system 1 carry out the task according to the functional task description. In the scenario shown in FIG. 1, the combination of the initial service A1 with each service E1, E2 and E3 and the combination of the initial service A2 with each service E1, E2 and E3 carry the predetermined task. In a next step what is known as an interface compatibility check is carried out, in which it is checked how far the interfaces of the initial services A1 or A2 are compatible with the interfaces of the final services E1 or E2 or E3, with compatibility meaning that a direct interaction is possible between the services by way of the service interfaces without interposing further services. In the instance shown in FIG. 1 it can be seen that only the service A1 is compatible with the service E1. This compatibility is indicated by the line L1 between the services A1 and E1. In some instances the method can now be terminated, since two compatible services have been found, which achieve the task set, so that the task can be implemented by way of the services.

As described below, it is however also possible to search for further paths that continue over a number of services to achieve the task set. This is possible using what is known as resource tree generation, in which for each initial service A1 and A2 services compatible with the initial service are first sought. To this end a message in the form of a lookup request is sent out from the initial service A1 or A2, with the message containing the information about the functional nodes sought according to the task set and various restrictions. These restrictions can be local restrictions for example relating to the availability and functionality of the resources of the services A1 and A2. For example the restriction can include data only being able to be provided by an initial service in a specific format.

The lookup request also contains a list, in which only the identification of the service sending the message is first stored. The compatible service, which receives the lookup request, checks whether a functional node sought according to the task set is assigned to it. If not, it adds its own identification to the list in the lookup request and forwards the lookup request to services that are compatible with it in its environment. These services then also check again whether they contain the functional node to be sought according to the task set. If not again, the identifications of the respective services are in turn added to the lookup request and the request is forwarded to further services that are compatible with the respective service. It is thus possible to generate what is known as a resource tree with a plurality of paths in all directions.

The search in a respective path is terminated in any case, when the service receiving the lookup request contains the functional node sought according to the task set. The search path thus generated is then defined as the solution path for the task set, with the service containing the sought functional node reporting back to the original initial service. A search for compatible services in a path is also terminated, when no compatible services can be found for a service. In this instance the search in this path is deemed to have failed. The search for solution paths is also limited temporally by a timeout, with the timeout being context-sensitive, in other words being able to be influenced or controlled by external signals.

FIG. 1 shows a schematic diagram using squares with arrows to indicate transmission of the lookup requests to compatible services. It can be seen that in addition to the direct connection E1 there are further paths to achieve the task set by way of the lines L2 and L3 or L2 and L4 as well as by way of the lines L5, L6 and L7. The broken line L8 also indicates by way of example a connection between the initial service A1 and the service E4, which does not represent a solution path, as the two services are either not mutually compatible or predetermined restrictions, sent with the lookup request, are not satisfied. As mentioned above, these restrictions are taken into account when generating the solution paths, it being checked when generating the paths by each service involved whether it satisfies the resource requirements predetermined by the restrictions. If these requirements cannot be satisfied, this path is suppressed during the search, even if the services are classed as mutually compatible. A preselection of possible solution paths is thus made during generation of the solution paths.

After generation of the solution paths, a selection is finally made, regarding which of the solution paths is to be used to implement the task set. Local restrictions and global restrictions can be taken into account in this process. Local restrictions are restrictions, which are only valid locally, in other words for a predetermined group of services, for example only for the services A1 and A2 of the technical device 2. An example of such a local restriction is a maximum bandwidth, with which data can be transmitted from a service. In contrast global restrictions apply in the whole of the technical system 1 and the device 2 to be integrated. These restrictions are sent out by all participants in the technical system and are intended to serve generally to resolve conflicts. Typical global restrictions in particular describe specific desired characteristics of the task to be executed. Such restrictions can for example be:
the task is to be executed as quickly as possible;
the task is to be executed using as little energy as possible;
the task is to be executed as economically as possible;
the task is only to be executed with trusted services;
the task is only to be executed with services having a specific security standard;
the task is to be executed in such a manner that a high level of availability of service resources continues to be provided.

In some instances there can even be competing global and local restrictions, with the local restrictions being overridden by the global restrictions.

In the embodiment of the method described here the selection of solution paths therefore has a number of stages. In a first step restrictions are already taken into account during the search for solution paths, with the restrictions containing clear go/no go decisions, according to which it is determined in which direction solution paths can branch. After determining the solution paths, one of the paths is in turn selected by way of restrictions, with dynamic restrictions preferably being taken into account during the selection, these including the local status, for example the energy stores of a service or the utilization of the capacity of a service. What are known as go/conditional-go decisions are then generated in the services of the solution paths, with the go/conditional-go decisions permitting the propagation of a solution path from one service to the next either without restriction or making it conditional upon the local status of the service in question. One criterion in the selection of the solution path can for example be that only solution paths with unambiguous go decisions are considered and a solution path is selected from these according to the global restrictions.

One possibility for optimizing the method described above is to use what is known as a functionality proxy service. The entire functionality of the services of the technical system is known to this service. To this end the functionality proxy service stores information from the functional nodes assigned to the services in a local storage unit. The search for solution paths then takes place on the basis of the information in the local storage unit. There is then no need for a discovery mechanism of a service to be newly integrated, since the corresponding information is supplied to the new service by way of the functionality proxy service. The possibility for optimization described above is particularly relevant for technical networks in the field of home and/or building automation, since there are often quasi-stationary statuses of specific network partners present there, which do not change over very long periods of time (e.g. the integration of a flat screen). Device groups to be newly added can therefore access these stationary statuses directly by way of the functionality proxy service.

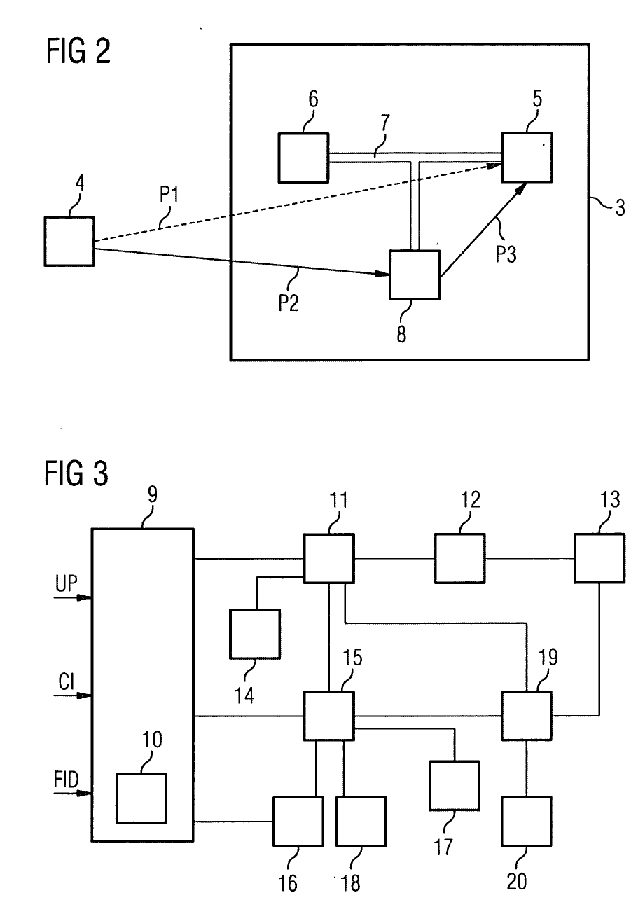

A specific example embodiment of the inventive method in the field of the remote control of technical devices in home automation technology is described below with reference to FIG. 2. The following scenario is considered according to FIG. 2:
there is a home automation system 3 with a plurality of technical devices;
a device 4 to be integrated into the home automation system, such as for example a PDA (PDA=Personal Digital Assistant) is to be incorporated dynamically into the system 3.

The device 4 is to control the heating system 5 within the home automation system 3, as shown in FIG. 2 by the broken arrow P1. The home automation system here is only physically accessible by way of a gateway 6, which is connected by way of an automation bus 7 to the heating system 5 and a heating control system 8. The task can be reproduced as follows in a functional description language:

<PDA> <link> <heating system>

The PDA 4 now first initializes a discovery mechanism, to find devices present in the system 3. The functional description of the task is then used to search for corresponding solutions. The possible characteristics of the interaction token <link> are also taken into account here. In particular connections for controlling the heating (interaction token <control heating> and connections for displaying the heating settings (interaction token <show heating settings>) are taken into account.

In the described scenario, after implementing an embodiment of the inventive method to search for solution paths, it can be seen that the heating system 5 cannot be used directly for the PDA 4, since there are no compatible interfaces present. Use is only possible if the heating control system 8 is interposed, as this is compatible both with the heating system 5 and the PDA 4. The availability of the resources of the heating system 5 and the heating control system 8 has also been taken into account dynamically here. The logical solution path found therefore includes the arrows P2 and P3 shown in FIG. 2, with the devices always being connected physically with the interposition of the gateway 6.

A further example for the application of an embodiment of the inventive method is the transmission of maintenance data of a technical device to a video display device in the form of a video stream. The initiator of the setting of this task is a device A, which is a maintenance data provider. This task can be formulated in a functional description language as follows:

<maintenance data provider> <maintenance data display> <video terminal>

The device A determines possible solution paths, preferably with the interposition of the functionality proxy service described above. It can be seen that a device B can display the maintenance data, not directly using the device A but with the interposition of a maintenance support device, which can visualize the data of devices in the system. During the search for suitable solution paths, the technical resources of the support device, in particular the bandwidth, coding method and possible image resolution of the device were taken into account particularly. Local restrictions of the device B were likewise included in the search, in particular the minimum resolution of the device, the visibility (individual user, room, group, etc.) and the current availability. These restrictions therefore refine the functional element <video terminal> of the functional description of the task.

As can be seen from the description of embodiments above, an embodiment of the inventive method has a number of advantages. Through the automated generation of solution paths taking into account available resources in particular it allows the automatic dynamic interfacing of new devices, without a manual configuration having to be carried out. The configuration outlay required is limited to the selection of suitable solution paths. It is a decisive factor here that by taking into account local and global restrictions when the devices are working together it is possible to incorporate new devices in a resource-efficient manner. An embodiment of the inventive method therefore allows a system to be deployed in a flexible manner for new, unanticipated possible uses, since new cooperation possibilities are sought automatically, if devices that are not directly compatible are to work together. It is also possible to respond dynamically to changing conditions in the technical system, for example to the loss of devices currently in use.

FIG. 3 shows a schematic diagram of the structure of a technical device for incorporation in a technical system according to an embodiment of the inventive method or for use as an already existing component in the technical system. The connecting lines shown in FIG. 3 between the individual components are only shown in a schematic and exemplary manner here and other or additional connections between the components may also be present.

The device includes a control service 9 for controlling the dynamic generation of solution paths. Restrictions UP (UP=User Policy) can be input into the control service 9 by the user. What is known as context information CI can also be taken into account by way of the service, the context information relating to restrictions in respect of the environment, in which the device is used. The task to be achieved is also supplied to a corresponding interpreter 10 in the form of a functional task description FTD.

The determination of combinations of initial and final services, which achieve the task set, and the search for suitable solution paths are implemented in the device in the resource tree generator 11, which makes the search request for compatible services, with the search request containing the required functional nodes according to the task set. The generator 11 is also connected in turn to a discovery service 12, by way of which it is first determined which devices are present in the technical system, into which the new device is to be incorporated. The discovery service 12 here is connected to a corresponding network interface 13, by way of which information is transmitted between the new device and the devices in the technical system.

The device in FIG. 3 also has a cache 14, in which the solution paths determined by the resource tree generator 11 are stored. The solution path is then selected by way of the selection unit 15, which takes into account local restrictions stored in a storage unit 16 and global restrictions stored in a storage unit 17 as well as in some instances existing context information CI and user restrictions UP. Restrictions relating to the supplied resources of the individual devices are also taken into account beforehand during the search for paths in the resource tree generator 11. These restrictions are stored in a storage unit 18 and are supplied to the resource tree generator 11 by way of the selection unit.

The device in FIG. 3 also has a management unit 19, which implements what is known as lease management, according to which it is determined at what time intervals specific services are made available. The management unit also processes lookup requests from other devices and forwards these in some instances to the resource tree generator 11, which then initializes the search for solution paths. The device in FIG. 3 also comprises a local storage unit 20, in which information from the services available locally in the device is stored.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for the dynamic service configuration of a technical system including a plurality of services, each with one or more interfaces, with two services in the technical system being compatible, when a direct interaction of the one service with the other service can be implemented by way of compatible service interfaces and with one or more functional elements of a functional description language being assigned respectively to existing services in the technical system and services to be integrated in the technical system and possible interactions between the services, with each functional element representing a functionality of a service or an interaction between two services,
the method comprising:
a) at least one of inputting and generating, for an interaction task to be implemented in the technical system between one or more new initial services to be integrated in the technical system and one or more final services already existing in the technical system, a functional task description in the functional description language, functional elements being determined for the initial and final services and their interactions by the functional task description;
b) using the functional task description and the functional elements assigned to the services and interactions to determine combinations of initial and final services, which achieve the interaction task to be implemented in the technical system;
c) implementing, if combinations of initial and final services have been found in step b), a search for compatible services for at least some of the initial services of the combinations of initial and final services, during which search the initial service searches for services compatible with it and the compatible services in turn search for services compatible with themselves, with the result that paths for successive compatible services are generated, with a path being defined as a solution path of the interaction task, when the initial service of the path and the compatible final service found correspond to a combination of initial service and final service found in step b); and
d) selecting, if solution paths were found in step c), one of the solution paths and implementing the interaction task along the selected solution path.

2. The method as claimed in claim 1, wherein before implementation of step c), it is checked in an intermediate step whether the combinations of initial and final services determined in step b) comprise mutually compatible services.

3. The method as claimed in claim 2, wherein in the event that in the intermediate step one or more combinations of mutually compatible services are determined, these combinations are defined beforehand in each instance as a solution path.

4. The method as claimed in claim 3, wherein in the event that in the intermediate step one or more combinations of mutually compatible services are determined, the method moves on to step d).

5. The method as claimed in claim 1, wherein the new initial services to be integrated in the technical system determine the services already existing in the technical system with the aid of a search method.

6. The method as claimed in claim 5, wherein the search method is at least one of a UPnP (Universal Plug and Play) method and a Bluetooth-based search method.

7. The method as claimed in claim 1, wherein the services existing in the technical system and the functional elements assigned to these services are stored in a storage unit and the search according to step c) is implemented in the storage unit.

8. The method as claimed in claim 1, wherein the search in step c) is implemented, until at least one of a predetermined number of solution paths has been found and at least one abort criterion is satisfied.

9. The method as claimed in claim 8, wherein the at least one abort criterion is a predetermined maximum time interval for the search for solution paths.

10. The method as claimed in claim 9, wherein the maximum time interval can be changed.

11. The method as claimed in claim 1, wherein during the search in step c), messages are sent between the services, containing the initial service (A1, A2) of the path and one or more functional elements of the final services (E1, . . . , E7) predetermined according to the functional task description.

12. The method as claimed in claim 11, wherein the identity of the service receiving the message is added to a message, in so far as a functional element predetermined according to the functional task description is not assigned to this service, and the message is then forwarded to compatible services.

13. The method as claimed in claim 1, wherein in the event that a functional element predetermined according to the functional task description is assigned to the service receiving the message, this service reports its identity back to the initial service of the path.

14. The method as claimed in claim 1, wherein predetermined restrictions are taken into account at least one of during the search in step c) and during the selection in step d).

15. The method as claimed in claim 14, wherein the restrictions comprise global restrictions valid in the whole technical system.

16. The method as claimed in claim 14, wherein the restrictions comprise local restrictions, only valid in a group of services, which relate in particular to the availability of physical resources in the group of services.

17. The method as claimed in claim 1, wherein the method is implemented in a technical system comprising a network made up of a plurality of technical devices, with one or more services of the technical system being contained in each device.

18. The method as claimed in claim 17, wherein the initial services to be integrated in the technical system are contained in an individual device to be integrated in the technical system.

19. The method as claimed in claim 17, wherein the network comprises at least one of a home and building automation system.

20. A technical system comprising a plurality of services and configured to implement the method as claimed in claim 1.

21. A technical device, comprising
means for at least one of inputting and generating a functional task description for an interaction task to be implemented in a technical system between initial services of the technical device to be integrated in the technical system and one or more final services already existing in the technical system;
means for determining combinations of initial and final services, which achieve the interaction task to be implemented in the technical system;
means for initializing the search for solution paths; and
means for selecting solution paths.

22. The technical device as claimed in claim 21 for use as a group of services already existing in the technical system, further comprising means for the processing of messages.

23. A computer program product with a program code stored on a machine-readable medium for executing the method as claimed in claims 1, when the program is run on a computer.

24. The method as claimed in claim 2, wherein the new initial services to be integrated in the technical system determine the services already existing in the technical system with the aid of a search method.

25. The method as claimed in claim 24, wherein the search method is at least one of a UPnP (Universal Plug and Play) method and a Bluetooth-based search method.
